(19) United States
(12) Patent Application Publication
(10) Pub. No.: US 2017/0368626 A1
(43) Pub. Date: Dec. 28, 2017

(54) Electrochemical Removal Of Material From A Workpiece

(71) Applicant: Siemens Aktiengesellschaft, Muenchen (DE)

(72) Inventors: Axel Arndt, Berlin (DE); Manuela Schneider, Berlin (DE); Martin Schaefer, Berlin (DE)

(73) Assignee: Siemens Aktiengesellschaft, Muenchen (DE)

(21) Appl. No.: 15/543,699

(22) PCT Filed: Jan. 7, 2016
(86) PCT No.: PCT/EP2016/050148

§ 371 Date: Jul. 14, 2017

(30) Foreign Application Priority Data
Jan. 22, 2015 (DE) 10 2015 201 080.5

(51) Int. Cl. B23H 3/04; B23H 9/14; B23H 7/26

(52) U.S. Cl. CPC B23H 3/04; B23H 7/26; B23H 9/14

(57) ABSTRACT

The present disclosure relates to electrochemical erosion of material from a workpiece. For example, a device for electrochemical erosion of material from a workpiece may include: a holder for the workpiece; an electrolyte carrier material impregnated with electrolyte; a voltage source imposing a negative potential on the electrolyte carrier; and a mechanical connection between the holder and the electrolyte carrier allowing a relative movement with at least one degree of freedom.

### CROSS-REFERENCE TO RELATED APPLICATIONS

This application is a U.S. National Stage Application of International Application No. PCT/EP2016/050148 filed Jan. 7, 2016, which designates the United States of America, and claims priority to DE Application No. 10 2015 201 080.5 filed Jan. 22, 2015, the contents of which are hereby incorporated by reference in their entirety.

### TECHNICAL FIELD

The present disclosure relates to electrochemical erosion of material from a workpiece. Teachings thereof may be embodied in methods and systems for electrochemical removal of material from a workpiece.

### BACKGROUND

A method and a device for electrochemical erosion are known for example from WO 2006/080948 A2 and from AU 2013242795 A1. Accordingly, devices for electrochemical erosion can be equipped with a brush or a sponge as electrolyte carriers, wherein the electrolyte in these structures can be sucked up on account of capillary forces. If these electrolyte carriers are then placed on a surface which is to be treated, then this enables a transporting of the electrolyte through the channels in the electrolyte carrier toward the surface which is to be treated. Using the devices, a method for electrochemical erosion on surfaces can be carried out. For example, in this case residues of a welding process, such as weld spatter, can be locally removed from the surface of a weld construction.

### SUMMARY

The teachings of the present disclosure may be used to improve the quality of the effect of the electrochemical erosion. For example, some embodiments may include methods for electrochemical erosion of material from a workpiece (12), in which an electrolyte carrier (14) is impregnated with an electrolyte, the electrolyte carrier (14) is placed on the surface (27) of the workpiece (14), wherein the workpiece (14) comes into contact with the electrolyte and a negative potential, with regard to the workpiece (12), is created on the electrolyte carrier (14), characterized in that a mechanically guided relative movement is executed between the workpiece (12) and the electrolyte carrier (14), which movement is predetermined by means of a mechanical connection between a holder (11) for holding the workpiece and the electrolyte carrier (14).

In some embodiments, the electrolyte carrier (14) is adapted to the surface structure of the workpiece in such a way that this has a cross section the contour of which accurately coincides, at least in one section, with the surface of the workpiece which is to be created, wherein for the movement of the electrolyte carrier relative to the workpiece (12) provision is made for at least one degree of freedom.

In some embodiments, the surface which is to be created consists of a hole (19). In some embodiments, the surface which is to be created forms a part of a cylinder (28). In some embodiments, the surface which is to be created consists of a groove (32).

In some embodiments, the electrolyte carrier (14) is moved in a linear and/or rotational manner relative to the workpiece (12) during the erosion. In some embodiments, the workpiece (12) is moved in a linear and/or rotational manner relative to the electrolyte carrier (14) during the erosion. In some embodiments, the electrolyte carrier is guided by means of a robot.

In some embodiments, a component which is produced by means of an additive production process is machined by means of the electrochemical erosion.

Some embodiments may include devices for electrochemical erosion of material from a workpiece (12), in which a holder (11) is provided for the workpiece (12), provision is made for an electrolyte carrier (14) which consists of a material which can be impregnated with electrolyte, a negative potential, with regard to the workpiece, can be created on the electrolyte carrier (14), characterized in that provision is made between the holder (11) and the electrolyte carrier (14) for a mechanical connection which allows a relative movement with regard to at least one degree of freedom.

In some embodiments, the mechanical connection allows a rotation and/or translation between holder (11) and electrolyte carrier (14).

### BRIEF DESCRIPTION OF THE DRAWINGS

Further details of the disclosure are described below with reference to the drawings. The same or corresponding drawing elements are provided in each case with the same designations and are explained several times only insofar as to how differences arise between the individual figures. In the drawing:

FIG. 1 shows an exemplary embodiment of the device according to the teachings of the present disclosure in schematic section and implementation of an exemplary embodiment of a method;

FIG. 2 shows as a side view another exemplary embodiment of the device according to the teachings of the present disclosure while implementing an exemplary embodiment of a corresponding method; and

FIG. 3 shows as a three-dimensional view a further exemplary embodiment of the device according to the teachings of the present disclosure while implementing a corresponding method.

### DETAILED DESCRIPTION

The teachings of the present disclosure may be embodied in methods and systems for electrochemical erosion. For example, in some embodiments, an electrolyte carrier is impregnated with an electrolyte. This electrolyte carrier, for example a sponge of a brush, is then placed on the surface of the workpiece, wherein the workpiece comes into contact with the electrolyte. A negative potential, with regard to the workpiece, is applied to the electrolyte carrier. This brings about an electrolytic erosion of material from the workpiece, wherein this material is electrochemically dissolved. This may be carried out in the case of metallic materials.

Some embodiments include a device for electrochemical erosion of material from a workpiece. This device has a holder for the workpiece. An electrolyte carrier consisting of a material which can be impregnated with electrolyte is provided, wherein this can be placed on the surface of a workpiece which is provided in the holder. Also, a negative potential, with regard to the workpiece, can be applied to the electrolyte carrier. This can be realised for example by an electrical connection point for a voltage source. This voltage source can then be connected to the electrolyte carrier by the negative pole, whereas the positive pole of the voltage source can be connected to the surface of workpiece which is located in the holder.

In some embodiments, a mechanically guided relative movement is executed between the workpiece and the electrolyte carrier. This is achieved by the electrolyte carrier being guided relative to the workpiece by means of a suitable mechanical device so that a defined movement of the electrolyte carrier can be executed on the surface of the workpiece. The mechanical guiding of the relative movement restricts the kinematic fixing of degrees of freedom of said relative movement, whereas the movement in other degrees of freedom is permitted. This can be achieved either by means of a suitable mechanical connection between the component and the electrolyte carrier, or use can be made of a programmable device, such as a robot arm, the movement of which can be accurately predetermined, as a result of which defined degrees of freedom are blocked and other degrees of freedom are used for the relative movement. As a result of this, it can be ensured that for example each of the regions of the workpiece which are to be machined can be fed to the treatment of the erosion in equal measure. In this way, the quality of the erosion effect can be improved.

In some embodiments, the electrolyte carrier is adapted to the surface structure of the workpiece in such a way that this has a cross section the contour of which accurately coincides, at least in one section, with the surface of the workpiece which is to be produced.

In some embodiments, a degree of freedom allows the movement of the electrolyte carrier relative to the workpiece. This degree of freedom can for example be provided by a movement direction perpendicular to the aforesaid cross section of the electrolyte carrier. In this way, structures can be produced which are defined by a cross section which extends on the workpiece in the direction of a direction which is perpendicular to the cross section. In this case, it can be for example a shoulder or a groove. This structure can be provided on or in a flat surface or else on or in the circumference of a rotationally symmetrical workpiece.

The surface which is to be created can also consist of a hole. This hole can be formed by means of a bore or be introduced into the component by another production method, for example an additive manufacturing process (also called an additive production process). If there are requirements on the walls of the hole for the surface condition which cannot be achieved by the selected production process for the hole, the hole can then be after machined by means of the method. The electrolyte carrier in this case has exactly the cross section of the hole. It can be introduced into the hole by means of a translational movement, wherein this movement can also be used to ensure a relative movement between the walls of the hole and the electrolyte carrier during the electrochemical erosion. If it concerns a circular cylindrical hole, the relative movement can be achieved by means of a rotation of the electrolyte carrier around its central symmetry axis.

The relative movement between the electrolyte carrier and the workpiece during the erosion can be rotational and/or linear. The relative movement can advantageously be created either by moving the workpiece beneath a fixed electrolyte carrier or by movement of the electrolyte carrier on the surface of the workpiece. Rotationally symmetrical components, such as shafts, can be made to rotate with respect to a fixed electrolyte carrier. If the components are very large and for example only small surface regions, such as holes, are to be machined, the electrolyte carrier may be moved relative to the stationary workpiece.

The electrolyte carrier can be guided by means of a robot. In this case, surfaces of the component which spatially are arranged in any manner can be machined. Machining by means of a robot may be appropriate if the geometry of the component is provided as a three-dimensional data set, in the way that this is ensured for production by means of additive manufacturing.

In some embodiments, the component, which is to be machined by the electrochemical erosion, is produced by means of an additive production process (also referred to an additive manufacturing). For example, laser fusion, laser sintering, and laser cladding are to be referred to as additive manufacturing processes. In this case, the components are built up in layers, and a stepped surface of the component can be formed. If the surface requirements for the components, however, require a surface quality which cannot be achieved by this “stepped” surface condition, then it is expedient to use the method according to the invention. Depending on the geometry of the component, some embodiments may include guiding the component or the use of an electrolyte carrier with a robot.

In some embodiments, there is a mechanical connection between the holder and the electrolyte carrier which allows a relative movement with regard to at least one degree of freedom. The positive pole of a voltage source can be connected to the workpiece and the negative pole of a voltage source can be connected to the electrolyte carrier. As a result of this, the the electrolyte carrier is impregnated with an electrolyte in the process. The mechanical connection of electrolyte carrier and workpiece may be accurately defined by its clamping in the holder, which is why the erosion effect as a result of the effected electrochemical erosion (e.g. electro polishing) can be accurately predetermined. In this case, the mechanical connection may allow a rotation and/or translation between holder and electrolyte carrier.

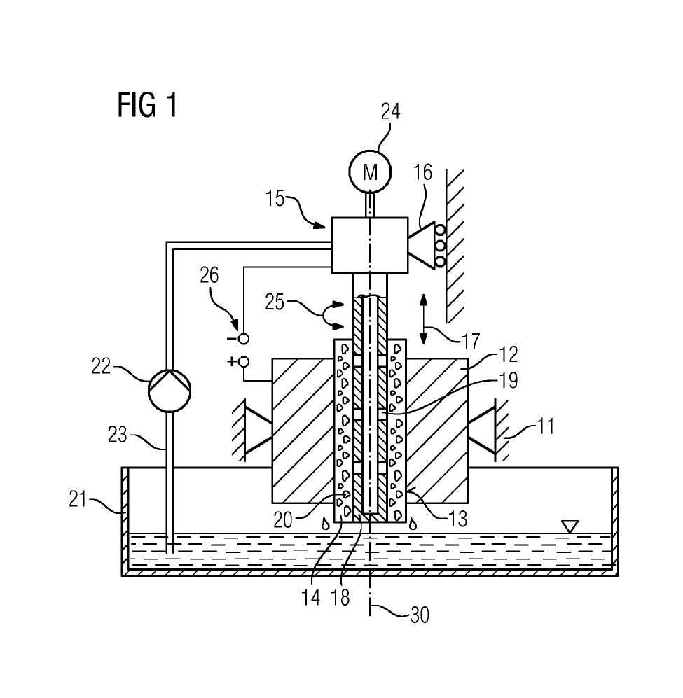

Some embodiments may include a device for electrochemical erosion such as that shown in FIG. 1. The device may include a holder 11 into which a workpiece 12 can be inserted. The workpiece 12 is provided with a hole 13 in the form of a bore, to be machined by means of the electrochemical erosion. For this purpose, a cylindrical electrolyte carrier 14 in the form of a sponge is introduced into the bore from the top. To this end, the electrolyte carrier 14 is fastened to a device 15 which for vertical displacement has a linear guide 16. The translational movement in the direction of the indicated double arrow 17 can also be used in order to create a relative movement between the electrolyte carrier 14 and the workpiece 12.

The electrolyte carrier 14 may be mounted on a supply pipe 18 which has holes 19 through which the electrolyte can make its way into the electrolyte carrier 14. Through pores 20 of the sponge-like structure of the electrolyte carrier 14, the electrolyte then reaches the walls of the hole 13. It then trickles into a collecting pan 21 from where it can be fed again to the device 15 via a suction pipe which is equipped with a pump 22. There, it makes its way into the supply pipe 18 again.

The device is also equipped with a motor 24 which can rotate the supply pipe 18 corresponding to the indicated double arrow 25. With this, the electrolyte carrier 14, which encompasses the supply pipe 18 in a ring-like manner, also rotates around the symmetry axis 30 of the supply pipe 18. This may create a relative movement between the electrolyte carrier 14 and the workpiece 12.

Also shown is a voltage source 26, the plus pole of which is in contact with the workpiece 12 and the minus pole of which is in contact via the device 15 with the electrically conducting supply pipe 18. By applying the potential, the wall of the hole 13 is electrochemically eroded. During this process, constituents of the workpiece material dissolve, and as a result of this the surface may be smoothed. It is also possible to dissolve impurities from the material of the workpiece and to improve for example the corrosion properties of the surface.

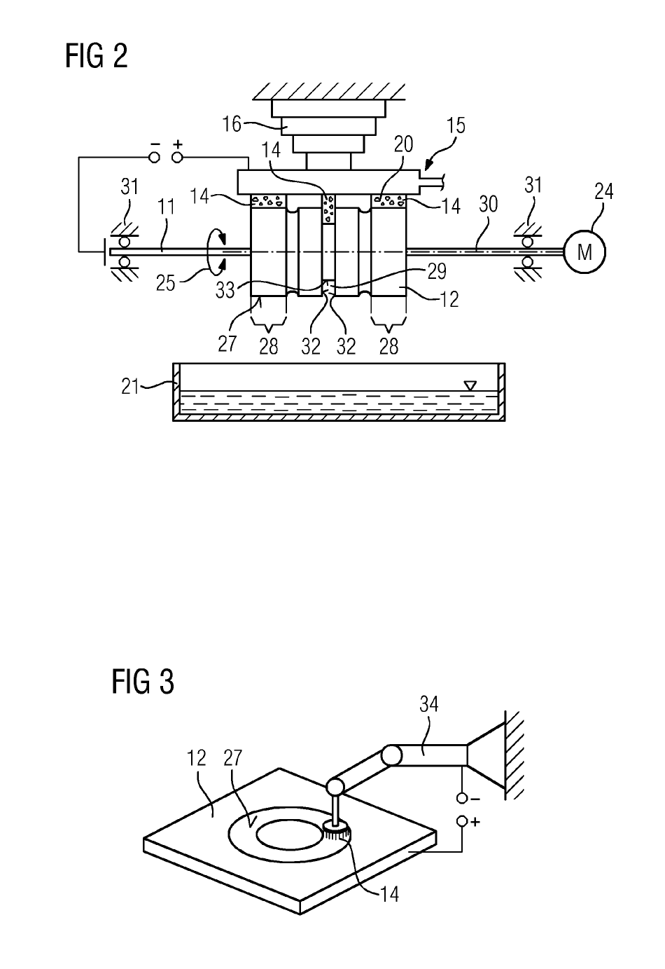

According to FIG. 2, a shaft is to be machined as the workpiece 12. The surface 27 of this shaft has at its ends two regions which are to be used as running surfaces and therefore are to have a surface condition which is to be improved by the electrochemical erosion (electro polishing). These regions, considered geometrically, constitute parts of cylinders 28. The shaft also has an annularly extending groove 29 which is also to be after machined by electrochemical erosion.

For the purpose of machining, the workpiece 12, via the rod-like holder 11, is rotatably supported around its symmetry axis 30 in bearings 31. The rotation is indicated by the double arrow 25 and is executed by means of the motor 26. During the rotation of the workpiece, the device 15, via the linear guide 16, is deposited from above onto the circumference of the component 12, wherein three electrolyte carriers 14 in the form of sponges come into contact with the component 12. Two of these electrolyte carriers erode material from the surface of the component 12 in the region of the cylinder 28. The third electrolyte carrier 14 is adapted in its cross section in such a way that it accurately fits into the groove 29. In this way, both the groove flanks 32 and the groove bottom 33 can be machined in the groove 29 at the same time.

A suction pipe 23 with a pump 22 and a structure comparable to the supply pipe 18 for supply of the electrolyte carrier 14 are not shown in FIG. 2, but are realized in a similar way to the embodiment according to FIG. 1. In this way, the electrolyte can be fed from the collecting pan 21 to the electrolyte carriers 14 and via the pores 20 be transported to the surface 27.

According to FIG. 3, the surface 27 which is to be treated consists of an annular region on a flat component 12. Used as an electrolyte carrier 14 in the case of FIG. 3 is a brush which is fastened on a robot arm 34. By means of this, the electrolyte carrier 14 can be repeatedly guided over the annular region of the surface 27 which is to be treated, wherein a material erosion is carried out in the process.

What is claimed is:

1. A method for electrochemical erosion of material from a workpiece, the method including:
placing an electrolyte carrier on a surface of the workpiece, the electrolyte carrier impregnated with an electrolyte, thereby bringing
the workpiece into contact with the electrolyte;
creating a negative potential, with regard to the workpiece, on the electrolyte carrier;
moving the workpiece and the electrolyte carrier in a mechanically guided relative movement between each other, wherein the movement is predetermined by a mechanical connection between a holder for holding the workpiece and the electrolyte carrier.

2. The method as claimed in claim 1, wherein the electrolyte carrier is adapted to the surface structure of the workpiece to create a cross section which coincides, at least in one section, with a desired contour for the surface of the workpiece;
wherein there is at least one degree of freedom for the movement of the electrolyte carrier relative to the workpiece.

3. The method as claimed in claim 2, wherein the desired contour for the surface comprises a hole.

4. The method as claimed in claim 2, wherein the desired contour for the surface comprises a part of a cylinder.

5. The method as claimed in claim 2, wherein the desired contour for the surface comprises a groove.

6. The method as claimed in claim 1, wherein the electrolyte carrier moves in a linear and/or rotational manner relative to the workpiece during the erosion.

7. The method as claimed in claim 1, wherein the workpiece moves in a linear and/or rotational manner relative to the electrolyte carrier during the erosion.

8. The method as claimed in claim 1, wherein the electrolyte carrier is moved by means of a robot.

9. The method as claimed in claim 1, wherein the workpiece comprises a component produced by means of an additive production process.

10. A device for electrochemical erosion of material from a workpiece, the device comprising:
a holder for the workpiece;
an electrolyte carrier comprising a material impregnated with electrolyte;
a voltage source imposing a negative potential, with regard to the workpiece, on the electrolyte carrier; and
a mechanical connection between the holder and the electrolyte carrier allowing a relative movement with at least one degree of freedom.

11. The device as claimed in claim 10, wherein the mechanical connection allows a relative rotation and/or translation between holder and electrolyte carrier.
